(19) United States
(12) Patent Application Publication
(10) Pub. No.: US 2014/0040761 A1
(43) Pub. Date: Feb. 6, 2014

(54) PROVIDING AN UPDATE ASSOCIATED WITH A USER-CREATED POINT OF INTEREST

(71) Applicants: Jia Liu, Sunnyvale, CA (US); Xincheng Zhang, Sunnyvale, CA (US)

(72) Inventors: Jia Liu, Sunnyvale, CA (US); Xincheng Zhang, Sunnyvale, CA (US)

(73) Assignee: Google Inc., Mountain View, CA (US)

(21) Appl. No.: 13/566,885

(22) Filed: Aug. 3, 2012

(51) Int. Cl. G06F 3/048; G06F 17/30

(52) U.S. Cl. 715/747

(57) ABSTRACT

The subject technology enables a user to create a point of interest based on a specified geolocation and allows one or more user to update the point of interest by posting messages. By way of example, the subject technology can provide an electronic map that enables the user to interactively choose the desired geolocation for the point of interest. Further, a user can create multiple points of interest for the same location, and have different audiences for each point of interest to the same location (e.g., a restaurant). This functionality provided by the subject technology also applies for multiple users creating points of interests to the same location. The subject technology designates a target audience for the point of interest. The target audience sets a scope of users that are permitted to view and post updates or messages to the point of interest.

### BACKGROUND

An online electronic map can display one or more points of interests corresponding to different geographic locations. A user can view the online electronic map to locate the points of interests.

### SUMMARY

The subject technology provides for providing an update associated with a user-created point of interest. The subject technology receives user input for generating a point of interest in which the generated point of interest is based at least on a specified geolocation or place. A level of access is then set for the generated point of interest in which the level of access is based on a target audience according to one or more categories of users. A message is received for updating information associated with the generated point of interest. Further the subject technology updates the information associated with the generated point of interest based on the received message.

Yet another aspect of the subject technology provides a system for providing an update associated with a user-created point of interest. The system includes memory, one or more processors and one or more modules stored in memory and configured for execution by the one or more processors. The system includes a point of interest (POI) processing module configured to receive user input for generating a point of interest, the generated point of interest based at least on a specified geolocation or place, and to set a level of access for the generated point of interest, the level of access based on a target audience according to one or more categories of users. The system also includes a message processing module configured to receive a message for updating information associated with the generated point of interest. Further, the system includes a POI updating module configured to update the information associated with the generated point of interest based on the received message.

The subject technology further provides for receiving user input for generating a point of interest in which the generated point of interest is based at least on a specified geolocation or place. A level of access is set for the generated point of interest in which the level of access is based on a target audience according to one or more categories of users. The subject technology receives a message for updating information associated with the generated point of interest. The information associated with the generated point of interest is then updated based on the received message. The subject technology receives subsequent user input for generating a second point of interest in which the second point of interest corresponds with a geolocation or place of an existing point of interest. Further, the subject technology sets a specified level of access for the second point of interest. The specified level of access is based on a specified target audience according to the one or more categories of users in which the specified target audience for the second point of interest is different than the target audience corresponding with the generated point of interest.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the following figures.

FIG. 1 conceptually illustrates an example process for providing an update associated with a user-created point of interest.

FIG. 2 conceptually illustrates an example process for providing one or more points of interests (POIs) according to a submitted search query.

FIG. 3 conceptually illustrates an example process for setting a time period for expiring points of interests (POIs).

FIG. 4 conceptually illustrates an example process for creating a point of interest that shares the same geolocation with an existing point of interest.

FIG. 5 conceptually illustrates an example graphical user interface (GUI) of some configurations of the subject technology.

FIG. 6 conceptually illustrates an example computing environment.

FIG. 7 conceptually illustrates an example application programming interface (API) architecture.

FIG. 8 conceptually illustrates an example architecture of a mobile device.

FIG. 9 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Location status updates can be provided in a social networking service to enable users to communicate a message associated with an identified geolocation of a user. However, this can require that the user perform a check-in to a specified geolocation in order to provide a message or status update associated with the geolocation. In the context of a social networking service, a check-in can be understood as a post associated with a geolocation or place that is typically included in the user's profile stream. Users can also lack the ability to create specified points of interest to associate status updates in the social networking service.

To address the aforementioned issues, the subject technology can be implemented as a mobile application on a mobile device (e.g., cell phone, smartphone, tablet, etc.) in some configurations. The user can create a point of interest based on a specified geolocation. By way of example, the subject technology can provide an electronic map that enables the user to interactively choose the desired geolocation for the point of interest (e.g., by either performing a search query for an address or dropping a pin onto the map). In one example, the subject technology can detect the user's current geolocation for associating with the point of interest. In another example, the user can provide a desired geolocation for the point of interest by providing an address, coordinates, etc. In some configurations, a data store can be utilized for storing each created point of interest.

Further, a user can create multiple points of interest for the same location, and have different audiences for each point of interest to the same location (e.g., a restaurant). This functionality provided by the subject technology also applies for multiple users creating points of interests to the same location.

Other types of parameters can also be set for a point of interest. For instance, the user can set a time period in which the point of interest expires. An expired point of interest can be removed from the data store of points of interests. Alternatively, the expired point of interest can be archived in the data store but does not permit additional updates or messages for the expired point of interest. Additionally, the point of interest can be associated with a scheduled event in some configurations. For instance, the user can create a point of interest for a scheduled event. In this manner, in addition to searching for a place or location, the subject technology enables the user to search for the scheduled event in order to locate the point of interest on the electronic map.

The subject technology can further designate a target audience for the point of interest. The target audience sets a scope of users that are permitted to view and post updates or messages to the point of interest. For instance, the target audience can include, but is not limited to, anyone on the web, a group of users (e.g., a social circle), an individual user, or private (e.g., only accessible to the user that created the point of interest), etc.

By way of example, the following information would be useful to users: 1) whether a parking lot is full, 2) whether a restaurant/bar has a long line, 3) if a gas station lowered its gas price, 4) if a popular product is out of stock in a store, and 5) if a sale starts for a popular product in a store, etc. The user can submit a message or update to the point of interest.

Depending on the target audience, other users can search for a point of interest (either via an electronic map or in the social networking service) in order to view the latest set of updates for the point of interest. In one example, the most recent N number of updates are shown for the point of interest and each update includes time and text of the update.

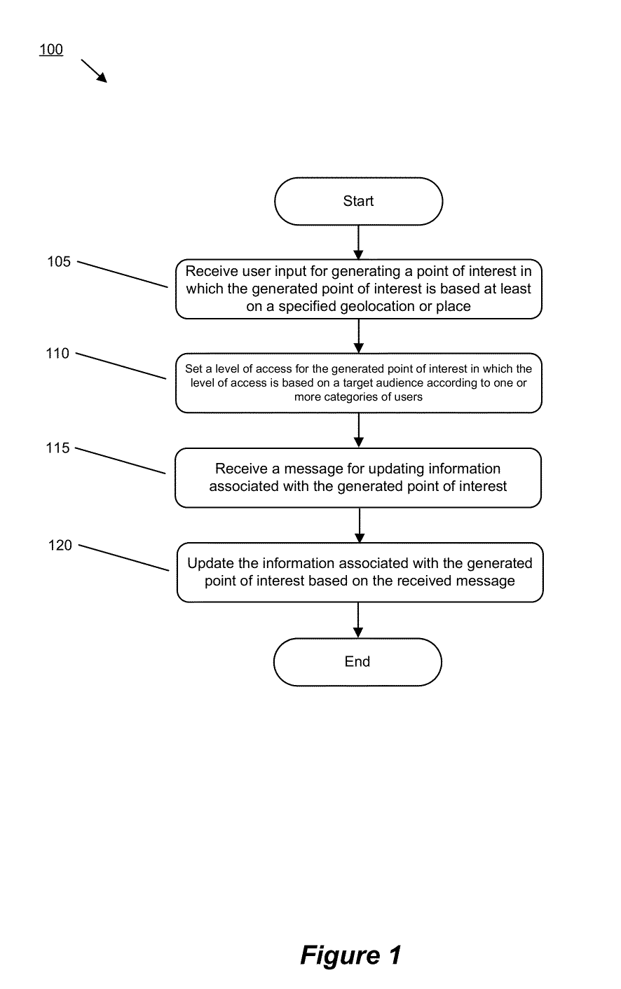

FIG. 1 conceptually illustrates an example process 100 for providing an update associated with a user-created point of interest. The process 100 is performed by one or more computing devices or systems in some configurations. For instance, a mobile application executing on a mobile device can perform the operations in the process 100 described in further detail below.

The process 100 begins at 105 by receiving user input for generating a point of interest in which the generated point of interest is based at least on a specified geolocation or place. In some configurations, the specified geolocation is associated with a physical location such as an identified place, a business, an airport, a metropolitan area, a neighborhood, a municipality, or a tourist attraction, etc. The term “place” refers to a geographic area with definite or indefinite boundaries. By way of example, the generated point of interest is associated with one of a place of business, parking lot, restaurant, and gas station, etc. Further, the specified geolocation or place is based on a user's current geolocation in one example. In an example in which the user has opted in to sharing location information, the user's geolocation is automatically detected in some configurations (e.g., via one or more location gathering techniques such as GPS, etc.).

Other associations to the geolocation can be provided and still be within the scope of the subject technology. For instance, in some configurations the generated point of interest is associated with a scheduled event that is occurring or will occur at the specified geolocation. Upon being generated, the process 100 can store the generated point of interest in a local and/or remote data store.

The process 100 at 110 sets a level of access for the generated point of interest. Access to the generated point of interest is specified/restricted by the user creating the point of interest. In one example, the access level is based on a target audience according to one or more categories of users. Default access levels (e.g., according to the users' category) can also be provided in order to assist the user creating the generated point of interest. For instance, the one or more categories of users include at least one of a user on the Internet, a group of users, an individual user, or a private user. Other categories of users can be provided and still be within the scope of the subject technology. The user creating the point of interest may wish to restrict access to the point of interest to a subset of users based on the aforementioned category of users. For instance, the level of access (e.g., according to the target audience) controls certain permissions with the generated point of interest such as determining a user's ability to view the point of interest or to provide comments, or perform other operations with respect to the point of interest. Once the level of access is set (granting and/or restricting certain permissions), the level of access is not modifiable by other users.

The process 100 at 115 the process 100 receives a message for updating information associated with the generated point of interest. Each generated point of interest includes information (e.g., metadata, comments, photos, audio, etc.) associated with the point of interest. The subject technology enables one or more users to post comments associated with the generated point of interest by submitting messages. By way of example, the message is in the form of a comment including text (e.g., alphanumerical characters) from a user. In lieu of a user check-in to the generated point of interest, the user submits a message to update information associated with the point of interest. As used herein, the term “check-in” refers to user activity that allows the user to share his or her current location to other users (e.g., in an online social network).

The process 100 at 120 updates the information associated with the generated point of interest based on the received message. In one example, the updated information can now be provided for display. The process 100 then ends.

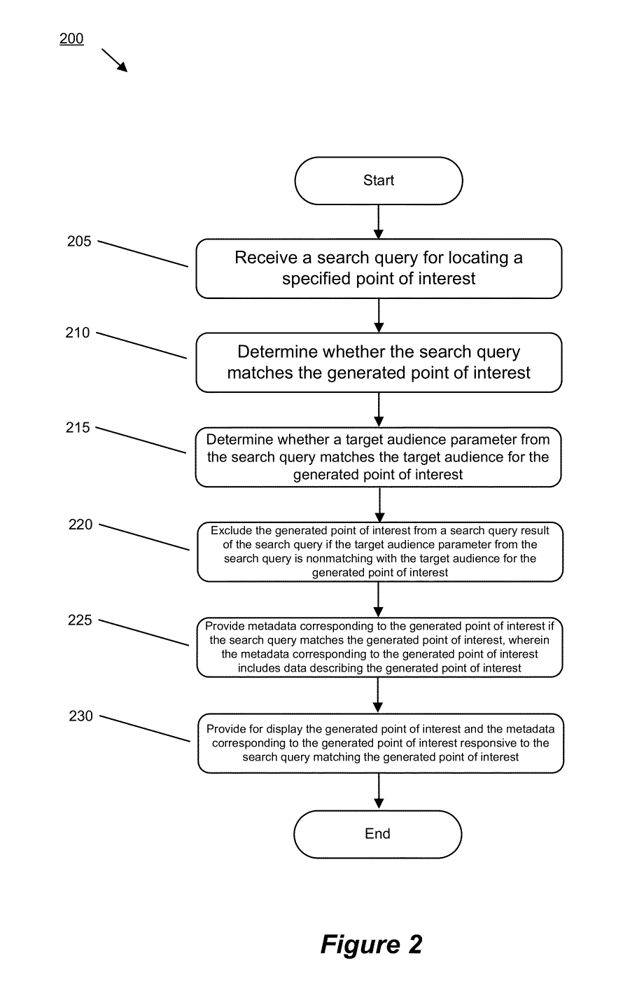

FIG. 2 conceptually illustrates an example process 200 for providing one or more points of interests (POIs) according to a submitted search query. The process 200 can be performed by one or more computing devices or systems in some configurations.

The process 200 begins at 205 by receiving a search query for locating a specified point of interest. For instance, a user can submit a search query for locating the specified point of interest. In one example, the search query includes a target audience parameter specifying one or more categories of users associated with a user that submitted the search query. All users, including the target audience, are able to specify the types of points of interests generated by others that are returned from the search query (e.g., as search options).

The process 200 at 210 determines whether the search query matches a generated point of interest (e.g., the generated point of interest described above in FIG. 1). Although the process 200 illustrates an example in which one point of interest (e.g., the generated point of interest) is determined to match the search query, it should be appreciated that the process 200 can determine whether the search query matches several points of interests and still be within the scope of the subject technology. For instance, one or more users can create different points of interests that are available for searching.

The process 200 at 215 determines whether the target audience parameter from the search query matches the target audience for the generated point of interest. As described in FIG. 1, the generated point of interest includes a target audience for specifying a level of access for the generated point of interest according to one or more categories of users.

The process 200 at 220 excludes the generated point of interest from a search query result of the search query if the target audience parameter from the search query is nonmatching with the target audience for the generated point of interest.

The process 200 at 225 provides metadata corresponding to the generated point of interest if the search query matches the generated point of interest. In one example, the metadata corresponding to the generated point of interest includes data describing the generated point of interest. The metadata further includes one or more comments from one or more users. The metadata further includes a respective time associated with each of the one or more comments from one or more users.

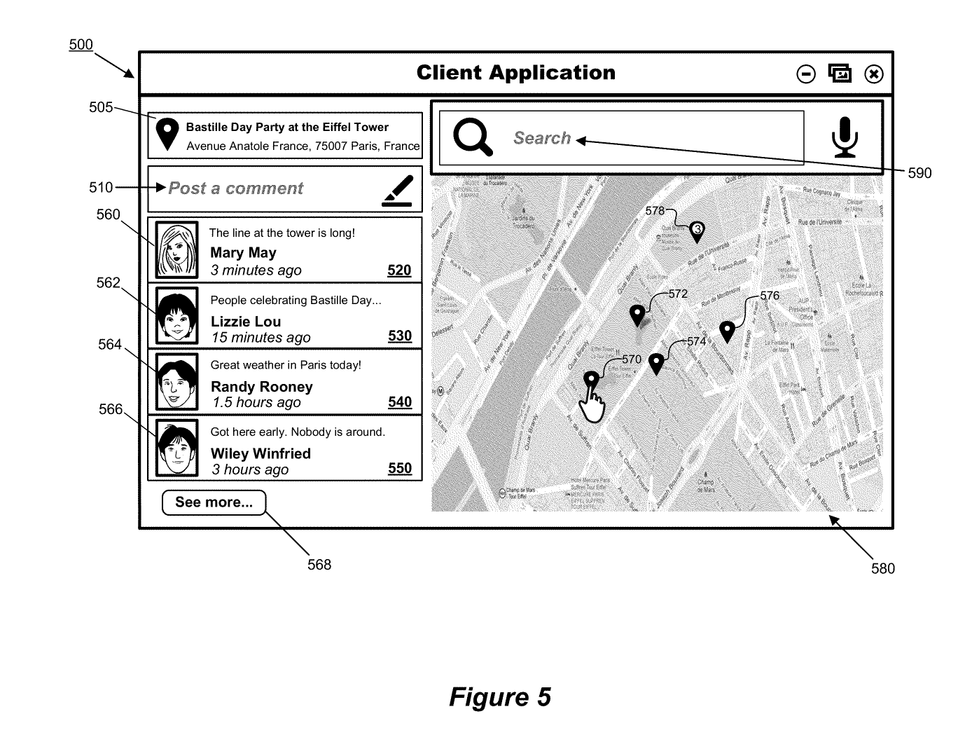

The process 200 at 230 provides for display the generated point of interest and the metadata corresponding to the generated point of interest responsive to the search query matching the generated point of interest. An example graphical user interface is described in further detail in FIG. 5. The process 200 then ends.

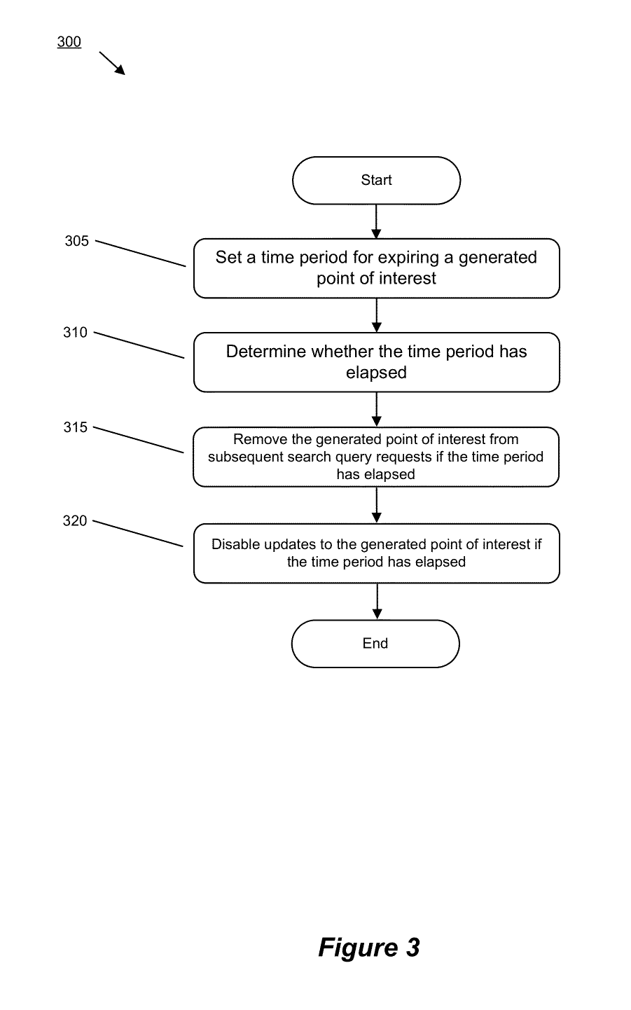

FIG. 3 conceptually illustrates an example process 300 for setting a time period for expiring points of interests (POIs). The process 300 can be performed by one or more computing devices or systems in some configurations. In one example, the process 300 can be performed conjunctively with the process 100 described in FIG. 1.

The process 300 begins at 305 by setting a time period for expiring a generated point of interest (e.g., the generated point of interest described by reference to FIG. 1). In some configurations, the user specifies the time period for expiring the point of interest as part of creating the point of interest (e.g., via setting an option or parameter). The user may wish to associate the point of interest to an event which ends at a specified time period (e.g., the expiry time). The process 300 at 310 determining whether the time period has elapsed. The process 300 at 315 removes the generated point of interest from subsequent search query requests if the time period has elapsed. Further, the process 300 at 320 disables updates (e.g., by not allowing further messages from one or more users) to the generated point of interest if the time period has elapsed. The process 300 then ends.

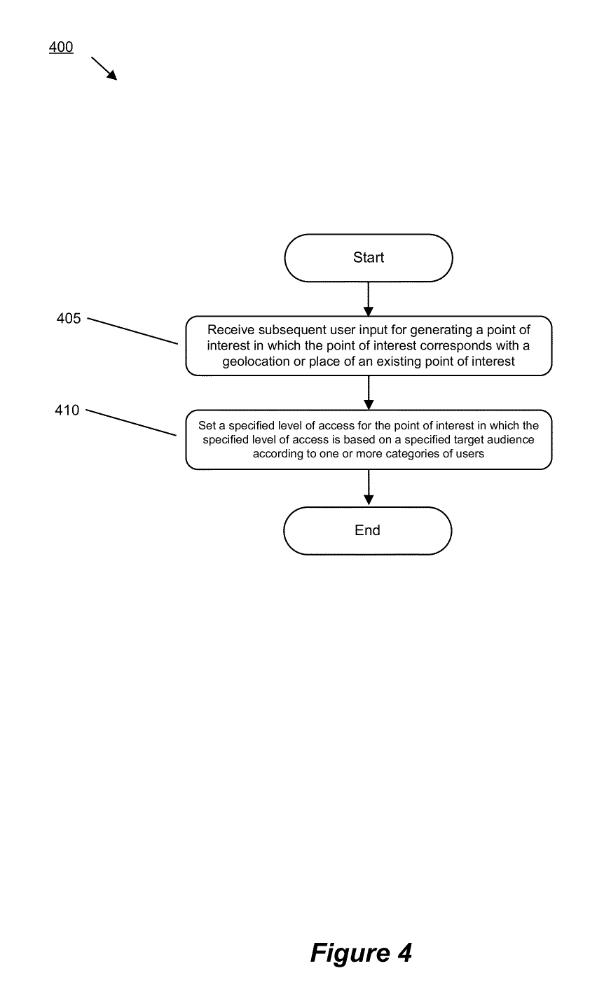

FIG. 4 conceptually illustrates an example process 400 for creating a point of interest that shares the same geolocation with an existing point of interest. The process 400 can be performed by one or more computing devices or systems in some configurations. In one example, the process 400 can be performed conjunctively with the process 100 described in FIG. 1.

The process 400 begins at 405 by receiving subsequent user input for generating a point of interest (e.g., a second POI) in which the point of interest corresponds with a geolocation or place of an existing point of interest. For instance, referring to FIG. 1, the user creates a preceding point of interest. The user can then create another point of interest (disparate from the preceding point of interest) that shares the same geolocation as the preceding point of interest.

The process 400 at 410 sets a specified level of access for the point of interest (e.g., the second POI) in which the specified level of access is based on a specified target audience according to the one or more categories of users. In one example, the specified target audience for the point of interest is different than a target audience corresponding with the existing point of interest. The process 400 then ends.

FIG. 5 conceptually illustrates a graphical user interface (GUI) 500 in which some configurations of the subject technology can be implemented. More specifically, the GUI 500 can include different sets of graphical elements for displaying one or more points of interests described in FIGS. 1-4. A graphical element can include, but is not limited to, a button, check box, radio button, slider, list box, drop-down list, menu, combo box, icon, text box, scroll bar, etc. In one example, the GUI 500 is displayed in a client application such as a web browser, mobile application, or desktop application. The GUI 500 is provided by an online social networking service and/or online map service in some configurations.

As illustrated in FIG. 5, the GUI 500 includes a widget including text input box 510, display areas 505, 520, 530, 540 and 550, and button 568. As used herein, the term “widget” refers to a lightweight application (e.g., lightweight in comparison to a full application suite or software package) providing a GUI that includes one or more graphical elements used to provide a specific application. In the example GUI 500, the display areas 520, 530, 540 and 550 include respective graphical representations 560, 562, 564 and 566 (e.g., an avatar, profile image, icon, etc.) corresponding to different users. In one example, the users are members of an online social networking service and opt in to sharing geolocation information.

The GUI 500 includes the display area 505 that provides information (e.g., metadata, other data, etc.) that describes a point of interest. In the example GUI 500, the information shown in the display area 505 shows the description of the point of interest and its address. One or more messages (e.g., text comments) are displayed in the GUI 500 in the display areas 520, 530, 540, and 550. The messages are provided according to the processes 100 and 200 respectively described in FIGS. 1 and 2. Each of the display areas 520, 530, 540 and 550 include a respective user's name and a time indicator showing a period of time that has elapsed since the respective user's message was posted. As shown in the example GUI 500, the messages are displayed in vertical ascending order (e.g., from top to bottom) based on the time indicator of the elapsed period of time since each message was posted. Other ways to display the messages can be provided and still be within the scope of the subject technology.

The GUI 500 includes an electronic map 580 that displays map location points 570, 572, 574, 576, and 578 that respectively correspond to respective points of interests for respective geolocations on the electronic map 580. As shown in the example GUI 500, a user provides input (e.g., touch selection input on a touch screen device as shown, mouse cursor input, etc.) for selecting the map location point 570. Upon selection, a predetermined N number of messages associated with the selected map location point 570 are shown as the different display areas 520, 530, 540 and 550. As described before, the display area 505 can include information for the selected map location point 570 corresponding to its associated point of interest (shown as “Bastille Day Party at the Eiffel Tower”). In a similar manner, the user can select any other map location point on the electronic map 580 to display N number of messages associated with the point of interest corresponding to the selected map location point. Additionally, in the example GUI 500, the map location point 578 includes a graphical indicator (shown as “3”) that indicates that more than one point of interest is associated with the map location point 578 for a specified geolocation on the electronic map 580. As described in Figure 4, more than one point of interest with different target audiences can be associated with the same geolocation.

The GUI 500 also includes the text input box 510 to enable the user to provide input for posting a comment associated with a selected map location point corresponding to a point of interest. Additionally, a text input box 590 is included in the GUI 500 to enable the user to submit a search query for a specified point of interest(s) (e.g., as described by reference in FIG. 2). One or more map location points corresponding to respective points of interests are then displayed in the electronic map 580 upon a successful search query (a search query that returns at least one point of interest based on the search query).

Although the example GUI 500 in FIG. 5 includes four different messages or posts, any number of messages can be included in the GUI 500 and still be within the scope of the subject technology. As further shown in the GUI 500, the button 568 is provided by the GUI 500 in order to display one or more additional messages.

Additionally, although the above description of FIG. 5 includes different example graphical elements in the GUI 500, some implementations can include other graphical elements in the GUI 500 and still be within the scope of the subject technology. Further, the GUI 500 is not required to include all of the aforementioned graphical elements.

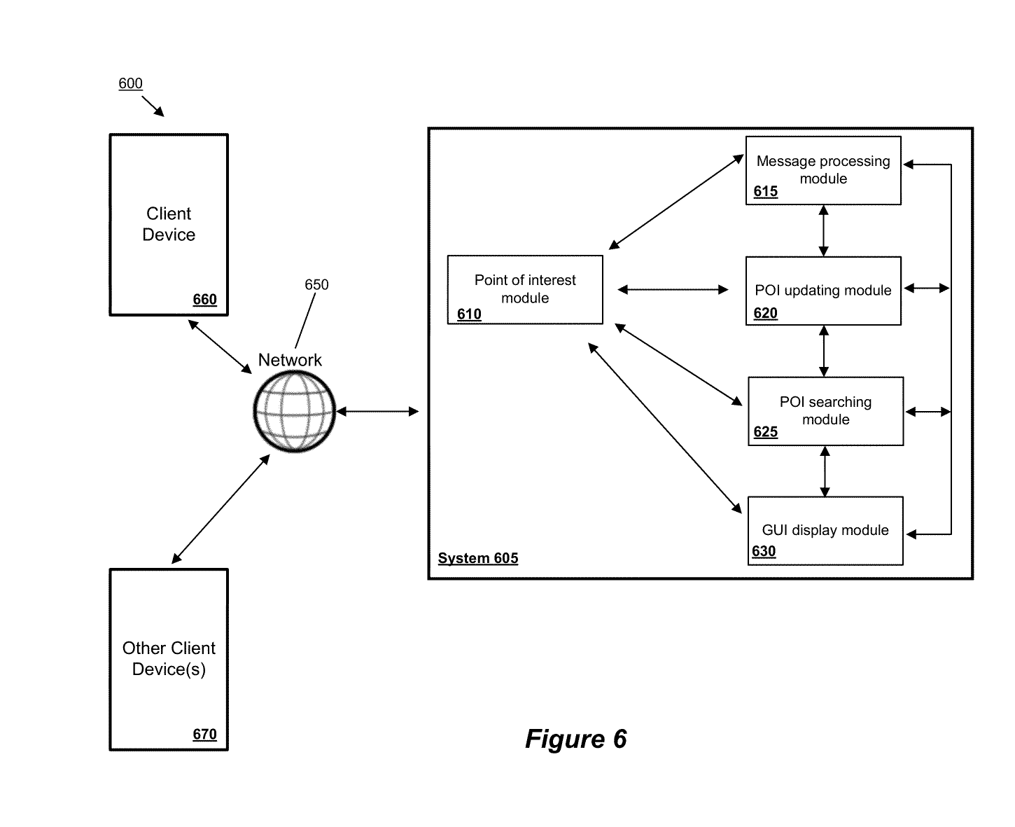

FIG. 6 conceptually illustrates an example computing environment 600 including a system. In particular, FIG. 6 shows a system 605 for implementing the above described processes in FIGS. 1-4 and for providing the GUI illustrated in FIG. 5. In some configurations, the system 605 is part of an implementation running a particular machine (e.g., a server).

The system 605 can include memory, one or more processors, and one or more modules stored in memory and configured for execution by the one or more processors. As shown in FIG. 6, the system 605 includes several modules for providing different functionality. The system 605 is configured to include a point of interest (POI) processing module 610, a message processing module 615, a POI updating module 620, a POI searching module 625 and a graphical user interface (GUI) display module 630. The POI processing module 610 is configured to receive user input for generating a point of interest. In some configurations, the generated point of interest based at least on a specified geolocation or place. The POI processing module 610 is further configured to set a level of access for the generated point of interest. In one example, the level of access is based on a target audience according to one or more categories of users. The message processing module 615 is configured to receive a message for updating information associated with the generated point of interest. The POI updating module 620 is configured to update the information associated with the generated point of interest based on the received message.

The POI searching module 625 is configured receive a search query for locating a specified point of interest, determine whether the search query matches the generated point of interest, and provide metadata corresponding to the generated point of interest if the search query matches the generated point of interest. The metadata corresponds to the generated point of interest includes data describing the generated point of interest in one example. The graphical user interface (GUI) display module 630 is configured to provide for display the generated point of interest and the metadata corresponding to the generated point of interest responsive to the search query matching the generated point of interest.

As further shown in FIG. 6, each of the aforementioned modules can be configured to communicate between each other. For instance, different data, messages, API calls and returns can be passed between the different modules in the system 605.

The system 605 can communicate over a network 650 with a client device 660. The client device 660 can each be configured to communicate with the aforementioned modules of the system 605. For instance, the client device 660 can transmit a request for creating a new point of interest, submitting a search request for one or more points of interests and/or updating a point of interest over the network 650 to the system 605. The system 605 can then transmit data responsive to any of the aforementioned requests over the network 650 to the client device 660. As further shown in FIG. 6, other client device(s) 670 can communicate over the network 650 with the system 605 in a similar manner.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

The following description describes an example API architecture in which some configurations of the subject technology can be implemented.

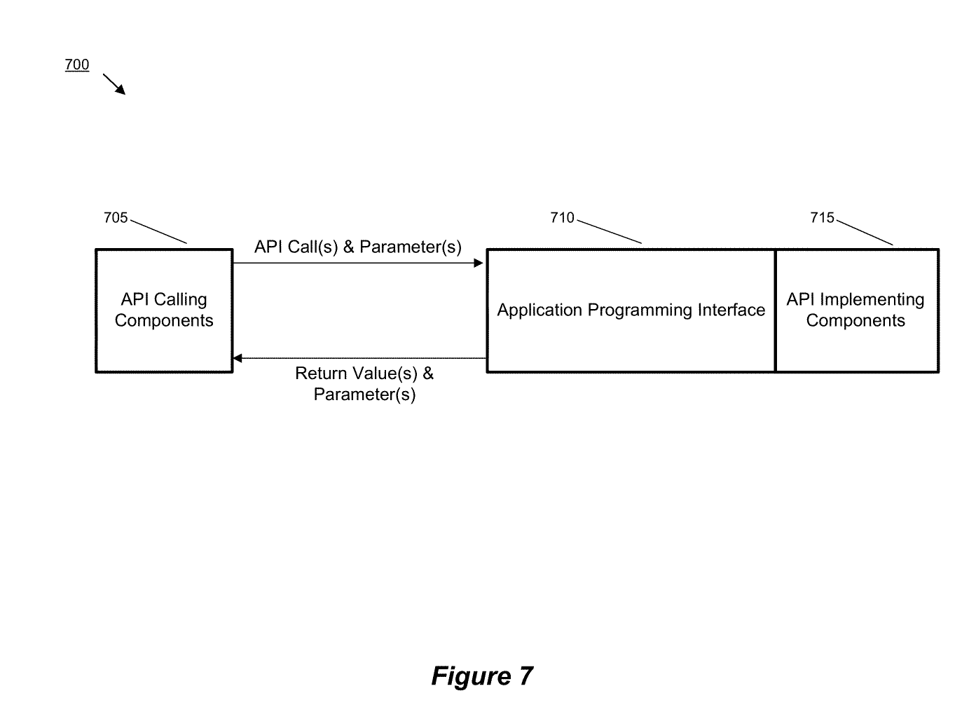

FIG. 7 is a block diagram illustrating an example API architecture, which can be used in some configurations of the subject technology. As shown in FIG. 7, the API architecture 700 includes the API implementing component 715 (e.g., an operating system, a library, a device driver, an API, an application program, software or other module) that implements the API 710. The API 710 specifies one or more functions, methods, classes, objects, protocols, data structures, formats and/or other features of the API-implementing component that can be used by the API-calling component 705. The API 710 can specify at least one calling convention that specifies how a function in the API implementing component receives parameters from the API calling component and how the function returns a result to the API calling component. The API calling component 705 (e.g., an operating system, a library, a device driver, an API, an application program, software or other module), makes API calls through the API 710 to access and use the features of the API implementing component 715 that are specified by the API 710. The API implementing component 715 can return a value through the API 710 to the API calling component 705 in response to an API call.

It will be appreciated that the API implementing component 715 can include additional functions, methods, classes, data structures, and/or other features that are not specified through the API 710 and are not available to the API calling component 705. It should be understood that the API calling component 705 can be on the same system as the API implementing component 715 or can be located remotely and accesses the API implementing component 715 using the API 710 over a network. While FIG. 7 illustrates a single API calling component 705 interacting with the API 710, it should be understood that other API calling components, which can be written in different languages (or the same language) than the API calling component 705, can use the API 710.

The API implementing component 715, the API 710, and the API calling component 705 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

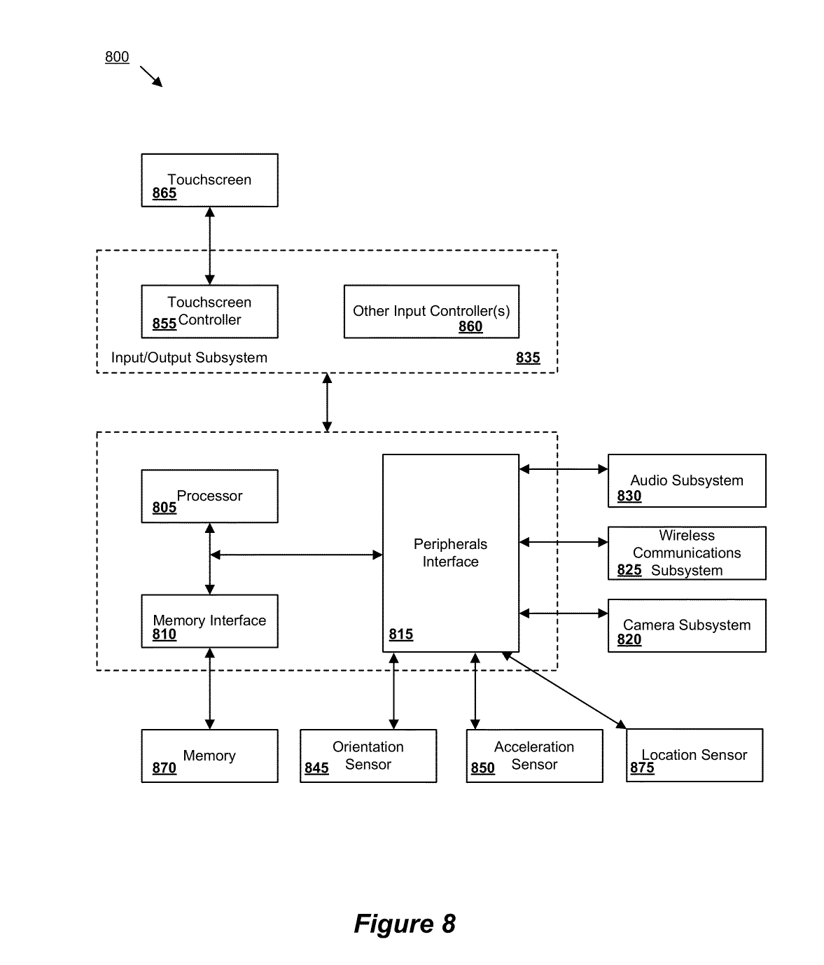

FIG. 8 is an example of a mobile device architecture 800. The implementation of a mobile device can include one or more processing units 805, memory interface 810 and a peripherals interface 815. Each of these components that make up the computing device architecture can be separate components or integrated in one or more integrated circuits. These various components can also be coupled together by one or more communication buses or signal lines.

The peripherals interface 815 can be coupled to various sensors and subsystems, including a camera subsystem 820, a wireless communication subsystem(s) 825, audio subsystem 830 and Input/Output subsystem 835. The peripherals interface 815 enables communication between processors and peripherals. The peripherals provide different functionality for the mobile device. Peripherals such as an orientation sensor 845 or an acceleration sensor 850 can be coupled to the peripherals interface 815 to facilitate the orientation and acceleration functions. Additionally, the mobile device can include a location sensor 875 to provide different location data. In particular, the location sensor can utilize a Global Positioning System (GPS) to provide different location data such as longitude, latitude and altitude.

The camera subsystem 820 can be coupled to one or more optical sensors such as a charged coupled device (CCD) optical sensor or a complementary metal-oxide-semiconductor (CMOS) optical sensor. The camera subsystem 820 coupled with the sensors can facilitate camera functions, such as image and/or video data capturing. Wireless communication subsystems 825 can serve to facilitate communication functions. Wireless communication subsystems 825 can include radio frequency receivers and transmitters, and optical receivers and transmitters. The aforementioned receivers and transmitters can be implemented to operate over one or more communication networks such as a Long Term Evolution (LTE), Global System for Mobile Communications (GSM) network, a Wi-Fi network, Bluetooth network, etc. The audio subsystem 830 is coupled to a speaker and a microphone to facilitate voice-enabled functions, such as voice recognition, digital recording, etc.

I/O subsystem 835 involves the transfer between input/output peripheral devices, such as a display, a touchscreen, etc., and the data bus of the processor 805 through the Peripherals Interface. I/O subsystem 835 can include a touchscreen controller 855 and other input controllers 80 to facilitate these functions. Touchscreen controller 855 can be coupled to the touchscreen 85 and detect contact and movement on the screen using any of multiple touch sensitivity technologies. Other input controllers 80 can be coupled to other input/control devices, such as one or more buttons.

Memory interface 810 can be coupled to memory 870, which can include high-speed random access memory and/or non-volatile memory such as flash memory. Memory 870 can store an operating system (OS). The OS can include instructions for handling basic system services and for performing hardware dependent tasks.

By way of example, memory can also include communication instructions to facilitate communicating with one or more additional devices, graphical user interface instructions to facilitate graphic user interface processing, image/video processing instructions to facilitate image/video-related processing and functions, phone instructions to facilitate phone-related processes and functions, media exchange and processing instructions to facilitate media communication and processing-related processes and functions, camera instructions to facilitate camera-related processes and functions, and video conferencing instructions to facilitate video conferencing processes and functions. The above identified instructions need not be implemented as separate software programs or modules. Various functions of mobile device can be implemented in hardware and/or in software, including in one or more signal processing and/or application specific integrated circuits.

The following description describes an example system in which aspects of the subject technology can be implemented.

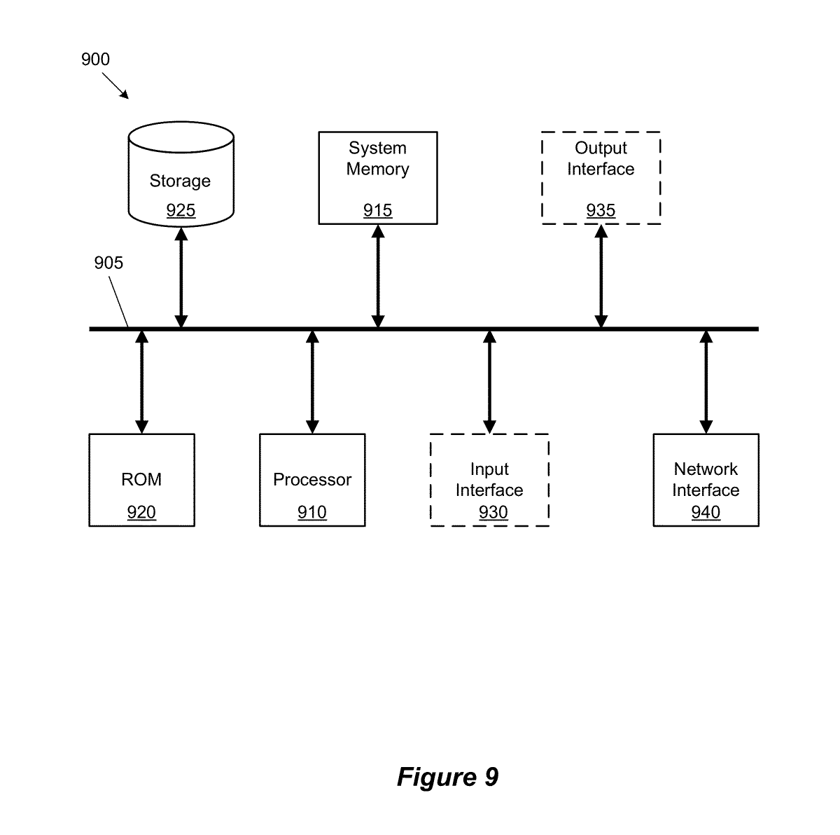

FIG. 9 conceptually illustrates a system 900 with which some implementations of the subject technology can be implemented. The system 900 can be a computer, phone, PDA, or any other sort of electronic device. In some configurations, the system 900 includes a television with one or more processors embedded therein. Such a system includes various types of computer readable media and interfaces for various other types of computer readable media. The system 900 includes a bus 905, processing unit(s) 910, a system memory 915, a read-only memory 920, a storage device 925, an optional input interface 930, an optional output interface 935, and a network interface 940.

The bus 905 collectively represents all system, peripheral, and chipset buses that communicatively connect the numerous internal devices of the system 900. For instance, the bus 905 communicatively connects the processing unit(s) 910 with the read-only memory 920, the system memory 915, and the storage device 925.

From these various memory units, the processing unit(s) 910 retrieves instructions to execute and data to process in order to execute the processes of the subject technology. The processing unit(s) can be a single processor or a multi-core processor in different implementations.

The read-only-memory (ROM) 920 stores static data and instructions that are needed by the processing unit(s) 910 and other modules of the system 900. The storage device 925, on the other hand, is a read-and-write memory device. This device is a non-volatile memory unit that stores instructions and data even when the system 900 is off. Some implementations of the subject technology use a mass-storage device (such as a magnetic or optical disk and its corresponding disk drive) as the storage device 925.

Other implementations use a removable storage device (such as a flash drive, a floppy disk, and its corresponding disk drive) as the storage device 925. Like the storage device 925, the system memory 915 is a read-and-write memory device. However, unlike storage device 925, the system memory 915 is a volatile read-and-write memory, such a random access memory. The system memory 915 stores some of the instructions and data that the processor needs at runtime. In some implementations, the subject technology's processes are stored in the system memory 915, the storage device 925, and/or the read-only memory 920. For example, the various memory units include instructions for processing multimedia items in accordance with some implementations. From these various memory units, the processing unit(s) 910 retrieves instructions to execute and data to process in order to execute the processes of some implementations.

The bus 905 also connects to the optional input and output interfaces 930 and 935. The optional input interface 930 enables the user to communicate information and select commands to the system. The optional input interface 930 can interface with alphanumeric keyboards and pointing devices (also called “cursor control devices”). The optional output interface 935 can provide display images generated by the system 900. The optional output interface 935 can interface with printers and display devices, such as cathode ray tubes (CRT) or liquid crystal displays (LCD). Some implementations can interface with devices such as a touchscreen that functions as both input and output devices.

Finally, as shown in FIG. 9, bus 905 also couples system 900 to a network interface 940 through a network adapter (not shown). In this manner, the computer can be a part of a network of computers (such as a local area network (“LAN”), a wide area network (“WAN”), or an Intranet, or an interconnected network of networks, such as the Internet. Any or all components of system 900 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A machine-implemented method for providing an update associated with a user-created point of interest, the method comprising:
receiving user input for generating a point of interest, wherein the generated point of interest is based at least on a specified geolocation or place;
setting a level of access for the generated point of interest, wherein the level of access is based on a target audience according to one or more categories of users;
receiving a message for updating information associated with the generated point of interest; and
updating the information associated with the generated point of interest based on the received message.

2. The method of claim 1, wherein the one or more categories of users include at least one of a user on the Internet, a group of users, an individual user, or a private user.

3. The method of claim 1, further comprising:
receiving a search query for locating a specified point of interest;
determining whether the search query matches the generated point of interest; and
providing metadata corresponding to the generated point of interest if the search query matches the generated point of interest, wherein the metadata corresponding to the generated point of interest includes data describing the generated point of interest.

4. The method of claim 3, wherein the metadata further includes one or more comments from one or more users.

5. The method of claim 4, wherein the metadata further includes a respective time associated with each of the one or more comments from one or more users.

6. The method of claim 3, further comprising:
providing for display the generated point of interest and the metadata corresponding to the generated point of interest responsive to the search query matching the generated point of interest.

7. The method of claim 3, wherein the search query includes a target audience parameter specifying one or more categories of users associated with a user that submitted the search query.

8. The method of claim 7, further comprising:
determining whether the target audience parameter from the search query matches the target audience for the generated point of interest.

9. The method of claim 8, further comprising:
excluding the generated point of interest from a search query result of the search query if the target audience parameter from the search query is nonmatching with the target audience for the generated point of interest.

10. The method of claim 1, further comprising:
setting a time period for expiring the generated point of interest.

11. The method of claim 10, further comprising:
determining whether the time period has elapsed; and
removing the generated point of interest from subsequent search query requests if the time period has elapsed.

12. The method of claim 1, wherein the generated point of interest is associated with one of a place of business, parking lot, restaurant, and gas station.

13. The method of claim 1, wherein the point of interest is associated with a scheduled event.

14. The method of claim 1, wherein the specified geolocation or place is based on a user's current geolocation.

15. The method of claim 14, wherein the user's geolocation is automatically detected.

16. The method of claim 1, further comprising:
receiving subsequent user input for generating a second point of interest, wherein the second point of interest corresponds with a geolocation or place of an existing point of interest; and
setting a specified level of access for the second point of interest, wherein the specified level of access is based on a specified target audience according to the one or more categories of users.

17. The method of claim 16, wherein the specified target audience for the second point of interest is different than a target audience corresponding with the existing point of interest.

18. A system for providing an update associated with a user-created point of interest, the system comprising:
memory;
one or more processors;
one or more modules stored in memory and configured for execution by the one or more processors, the modules comprising:
a point of interest (POI) processing module configured to receive user input for generating a point of interest, the generated point of interest based at least on a specified geolocation or place, and to set a level of access for the generated point of interest, the level of access based on a target audience according to one or more categories of users;
a message processing module configured to receive a message for updating information associated with the generated point of interest; and
a POI updating module configured to update the information associated with the generated point of interest based on the received message.

19. The system of claim 18, further comprising:
a POI searching module configured receive a search query for locating a specified point of interest, determine whether the search query matches the generated point of interest, and provide metadata corresponding to the generated point of interest if the search query matches the generated point of interest, wherein the metadata corresponding to the generated point of interest includes data describing the generated point of interest.

20. The system of claim 19, further comprising:
a graphical user interface (GUI) display module configured to provide for display the generated point of interest and the metadata corresponding to the generated point of interest responsive to the search query matching the generated point of interest.

21. A machine-readable medium comprising instructions stored therein, which when executed by a machine, cause the machine to perform operations comprising:
receiving user input for generating a point of interest, wherein the generated point of interest is based at least on a specified geolocation or place;
setting a level of access for the generated point of interest, wherein the level of access is based on a target audience according to one or more categories of users;
receiving a message for updating information associated with the generated point of interest;
updating the information associated with the generated point of interest based on the received message;
receiving subsequent user input for generating a second point of interest, wherein the second point of interest corresponds with a geolocation or place of an existing point of interest; and
setting a specified level of access for the second point of interest, wherein the specified level of access is based on a specified target audience according to the one or more categories of users, wherein the specified target audience for the second point of interest is different than the target audience corresponding with the generated point of interest.
